(19) United States
(12) Patent Application Publication
(10) Pub. No.: US 2011/0192265 A1
(43) Pub. Date: Aug. 11, 2011

(54) CIRCLE CUTTER AND TOOL WITH T-SQUARE

(76) Inventor: Regina Yoder, Arthur, IL (US)

(21) Appl. No.: 13/125,628

(22) PCT Filed: Oct. 26, 2009
(86) PCT No.: PCT/US2009/062137

§ 371 Date: Apr. 22, 2011

Related U.S. Application Data
(60) Provisional application No. 61/108,331, filed on Oct. 24, 2008.

(51) Int. Cl. B26D 3/00; B26D 1/18; B26D 7/01

(52) U.S. Cl. 83/522.19; 83/677

(57) ABSTRACT

A kit for use in making a scrapbook. The kit including a cutting mat having a plurality of openings along one edge and a notch locating along an opposed edge. A T-square type crosspiece includes pins and is secured to the cutting mat via the openings. The crosspiece also includes grooves. A ruler or straight edge includes pins at one end for pivotal connection to the T-square crosspiece. The other end includes a flange for engagement with the notch to secure the straight edge in place. A circle cutter is also provided and includes an arm to slidingly receive a handle and base. At one end of the are is located a blade housing having a rotatable knob.

### CROSS-REFERENCE TO RELATED APPLICATION

This application claims the benefit of U.S. Provisional Application No. 61/108,331, filed Oct. 24, 2008, which is incorporated herein by reference.

### TECHNICAL FIELD

The present invention relates to scrapbooking and in particular to, tools used in scrapbooking, including a cutting mat and a ruler with a T-square feature, and also including a circle cutter.

### BACKGROUND ART

The making of memory albums, more commonly known as “scrapbooking” has become a growing hobby in the last several years. Part of preserving memories is cropping photos into different shapes and arranging them in an attractive way, then embellishing the page with an array of different mediums, such as background mats, strips of paper, stickers and stamps. Finally, thoughts and memos are added to the page. This writing is otherwise known as “journaling”.

One of the most common shapes that photos are cropped into is a circle. Often colored paper, also cut into a circle, is used as a background mat for the photo. If a person wants to cut a circle out of a circle, or a donut shape, two separate cuts must be made at different intervals from the center of the circle.

When cropping photos or cutting paper into various shapes, many users desire a decorative cut rather than a straight edge. Many different blade patterns are available in scissors, which require that the user make a cut the length of the scissors, then attempt to line up the design exactly before proceeding with the next cut so that the design is not interrupted at any point. If a strip is desired, the same care must be taken to align the patterns so that they match the pattern parallel to them.

If a user wants to create a strip of paper with which to embellish the page, again, two cuts must be made, and extra care taken to make the two cuts parallel to each other.

When stamping, journaling or arranging stickers, a ruler is often used as a straight edge for aligning words, letters, or images in a straight line; however, it is often very difficult to properly align the material as, among other things, the paper and/or ruler may move during use.

International patent application no. PCT/US2006/011885 having publication no. WO/2006/105389, discloses scrapbooking tools and is incorporated herein by reference.

Therefore, there is a need to produce scrapbooking tools that are user-friendly and address the problems with the prior tools and methods, while being economical and easy to manufacture.

### SUMMARY OF THE INVENTION

The present invention provides a kit for use in making a scrapbook. The kit includes a cutting mat providing a working surface and a bottom surface, and a first edge with a first cutting mat attachment, and a second edge opposite from the first edge and having a second cutting mat attachment, and a straight edge tool having a bottom surface adapted for resting upon the working surface, a first end having a first end attachment for removably coupling to the first cutting mat attachment, and a second end having a second end attachment for removably coupling to the second cutting mat attachment.

The present invention also provides a circle cutter adaptable for use in making a scrapbook. The circle cutter includes a longitudinally extending arm having a first end and a second or blade end, the arm having a longitudinal length, the arm having a slot extending longitudinally at least a portion of the length of the arm, a blade housing located at the blade end, the blade housing having a lower surface and a blade capable of extending below the lower surface, the blade is aligned perpendicular to the arm, and a knob rotatably located on the blade housing, a locking mechanism located at the slot, the locking mechanism having an unlocked and locked condition, wherein in the unlocked condition, the locking mechanism is generally free to move along the slot, and wherein in the locked condition, the locking mechanism is secured with respect to the arm, and a handle and base portion, the handle portion extending from the locking mechanism above the arm, the base portion located below the arm and extends from the locking mechanism, wherein the handle and base portion are free to rotate within the slot with the locking mechanism in the locked condition, and the handle and base portion move with the locking mechanism along the slot with the locking mechanism in the unlocked position.

### BRIEF DESCRIPTION OF THE DRAWINGS

FIG. 1 is a perspective view of a cutting mat in accordance with the present invention.

FIG. 2 is a perspective view of an elongated tool in accordance with the present invention.

FIG. 3 is a top view of the tool of FIG. 2.

FIG. 4 is a front view of the tool of FIG. 2.

FIG. 5 is a side view of the tool of FIG. 2.

FIG. 6 is an exploded view of the locking end of the tool of FIG. 2.

FIG. 7 is a top view of the T-square cross piece in accordance with the present invention.

FIG. 8 is a front view of the cross piece of FIG. 7.

FIG. 9 is a side view of the cross piece of FIG. 7.

FIG. 10 is a bottom perspective view of the cross piece of FIG. 7.

FIG. 11 is a perspective view of the circle cutter in accordance with the present invention.

FIG. 12 is a side view of the circle cutter of FIG. 11.

FIG. 13 is a top view of the circle cutter of FIG. 11.

FIG. 14 is a front view of the circle cutter of FIG. 11.

FIG. 15 is an exploded view of the circle cutter of FIG. 11.

### DETAILED DESCRIPTION OF THE INVENTION

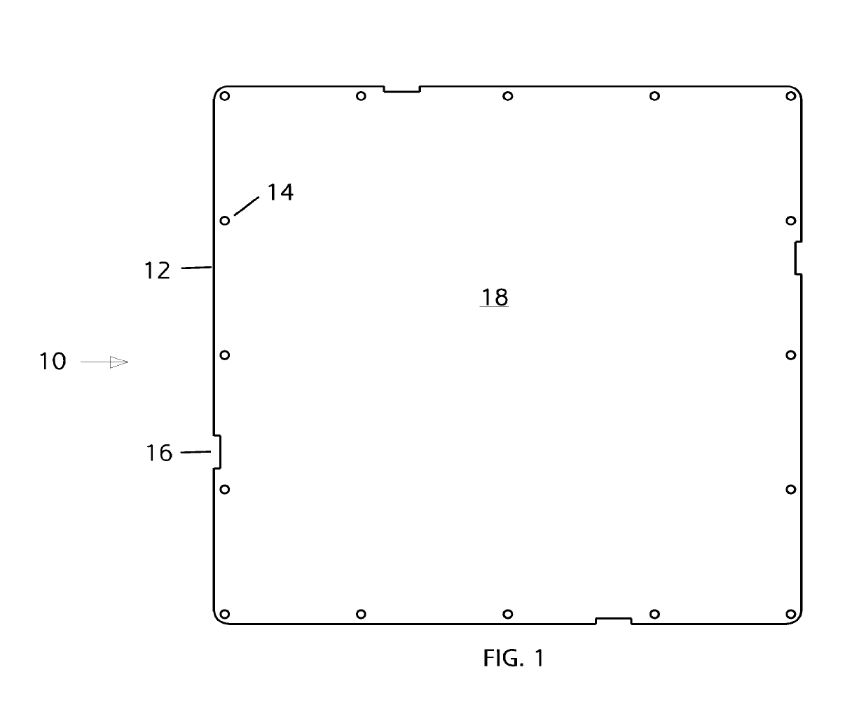

FIG. 1 shows the cutting mat in accordance with the one embodiment of the present invention. The cutting mat 10 shown in FIG. 1 is substantially square shaped having four edges 12. As shown along one edge, a plurality of holes 14 are shown, as well as a notch 16 and measuring indicia. The other edges are similarly arranged and provided. The cutting mat further includes a working surface 18 which includes a non-slip material. The working surface includes a grid pattern with various angularly arranged reference lines extending from one of the edges.

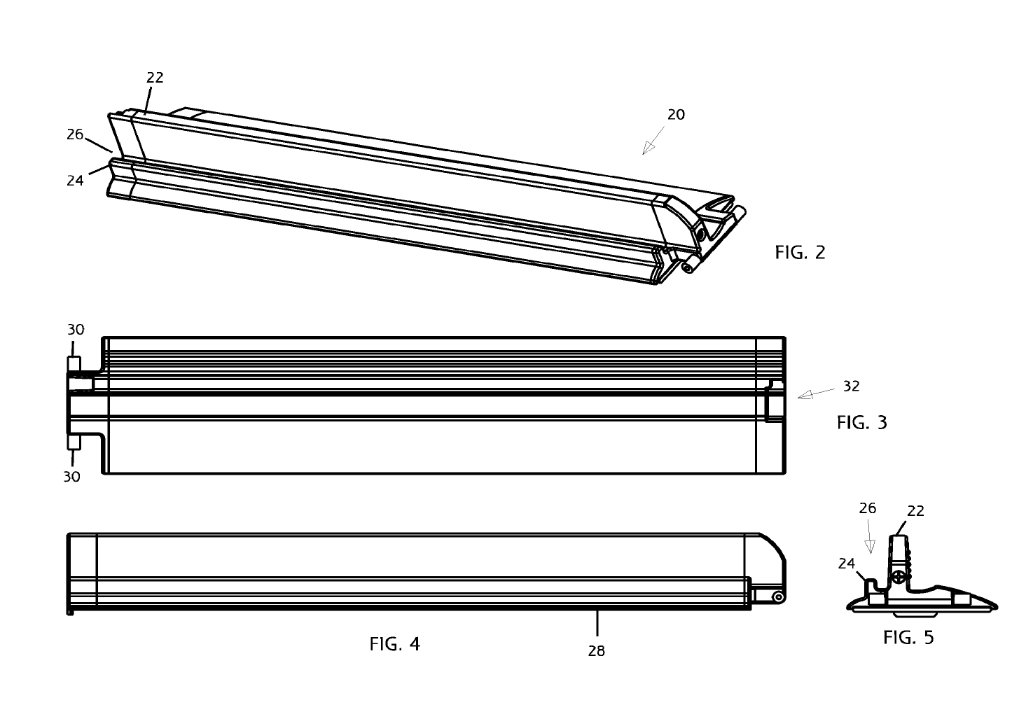

FIG. 2 shows a perspective view of an elongated tool 20 which is used as a straight edge and ruler. The elongated body of the tool is designed for working on substantially flat surfaces such as the cutting mat. As shown in FIGS. 2-6, the elongated tool includes a handle 22 and a rail 24 which together define a groove 26 therebetween. The rail and groove are adapted for receiving and guiding various attachments along the rail surface. The various attachments have been described elsewhere. For example, the groove may accept, among other attachments, a guide attached to a rotary cutter. The guide with the rotary cutter, once attached to the main body using the groove, may then move parallel to the groove along the length of the tool, with the tool acting as a stabilizer and guide.

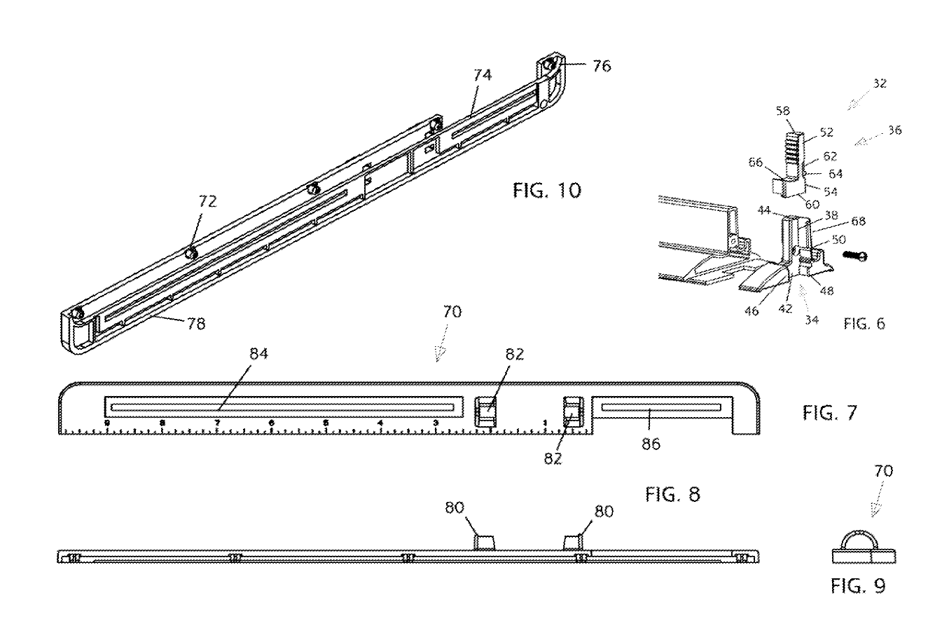

The bottom surface 28 of the elongated tool includes a non-slip pad (e.g., rubber). The pads provide friction, and thus stability, when pressure is applied to the top side of the tool. One end of the elongated tool includes two pins 30 extending perpendicular to the elongated tool. As will be explained further below, the two pins are used to provide a pivotal connection to the cutting mat. The other end of the elongated tool includes a lock 32 for locking the elongated tool to the cutting mat via one of the notches. FIGS. 3 and 6 show that the movable lock includes a recess or channel 34 for receiving a movable latch 36. A back wall 38, front wall and side wall 42 define a generally L-shaped channel. An abutment 44 is located at the upper end of the channel. The outer open end of the channel includes a left retaining edge 46 and a right retaining edge 48. A horizontal groove 50 extends along the back wall. The movable latch includes a stem 52 and foot 54 which define a generally L-shaped latch. A top end of the latch includes an abutment surface 58. A flange 60 extends along a left side of the foot and below the foot. A clip 62 is provided on the back of the stem and includes a horizontally extending bead 64. The front portion of the foot includes a vertically extending groove 66 on the left side of the foot. A vertical edge 68 also extends along the intersecting back side and left side of the stem. It will be understood that the movable latch includes an upper, or locked, position and a lower, or locked, position. In the upper unlocked position, the abutment surface 58 of the latch is engaged with the abutment surface 44 of the edge tool. Further, the bead abuts a ridge located above the groove 50. In the lower, or locked, position, the horizontally extending bead 64 is snap fitted into the horizontally extending groove 50. In the lower locked position, the flange 60 extends below the bottom surface 28 of the edge tool. The movable latch moves between the upper and lower positions with the various edges guiding and retaining the latch in position.

FIGS. 7-10 show the T-square cross piece 70. The T-square cross piece includes a plurality of two-piece flexible pins 72, which are received by the holes in the cutting mat. A generally straight edge 74 with curved end portions 76 receives a corresponding edge of the cutting mat to further secure the T-square cross piece to the cutting mat. The T-square cross piece includes a lower surface which the T-square cross piece secured to the cutting mat, the lower surface is level with the lower surface of the cutting mat. Thus, the cutting mat and attached T-square cross piece will rest upon a table or other surface in a level manner. The T-square cross piece further includes two opposed facing raised surfaces 80 each having a groove 82 with an open end facing one another and a closed end. The grooves further open at the top. In one embodiment, the grooves may have an upper opening slightly smaller than below. It will be understood that the two raised surfaces provide a snap fit connector for receiving the two pins at the end of the main tool. Thus, with the T-square cross piece secured to the cutting mat, the main tool may be snapped fit or otherwise placed within the pivotal connector of the T-square cross piece to provide a pivotal connection between the T-square cross piece and the cutting mat. With the main tool secured via the pivotal connection to the cutting mat, the other end of the main tool may be further secured to the cutting mat such as by moving the movable latch to the lower locked position. In the lower locked position, the flange of the movable latch will extend into the notch of the cutting mat, so as to further secure the main tool to the cutting mat. The T-square cross piece further includes a first longitudinally extending groove 84 and a smaller longitudinally extending groove 86. Each groove may receive a slidable marker which slides along the groove and may be used by the user in connection with measuring and providing reference points. The T-square cross piece includes ruler indicia along the edge.

It will be understood from the above description that the T-square cross piece may be snapped into place using the holes on the cutting mat and the flexible two piece pins on the T-square cross piece. The main tool may be grasped by the handle and then snap fit the pins into the T-square cross piece. The main tool may then be raised off of the cutting mat via the pivotal connection. The user may then place or move the paper on the cutting mat as desired. The main tool is then lowered via the pivotal connection onto the paper and the cutting mat. The other end of the main tool is then secured to the cutting mat by moving the movable latch to the lower position so that the flange of the movable latch extends into a respective notch. It will be appreciated that the main body secures in place easily on one end with the T-square press piece and the other end with the latch. By adding the T-square cross piece the user is provided added security that the paper will not bunch or bind as the user is cutting the paper. The main tool may be easily removed by moving the latch to the upper unlocked position and lifting the main tool off the paper surface via the pivotal connection without inadvertently moving the paper with respect to the working surface. The main tool may then be released from the T-square cross piece via the snap fit pivotal connection.

It will be appreciated that the main tool may be used on the cutting mat without connection to the T-square cross piece, so that the ruler may be used free form to create different angles, for example.

The main tool body accommodates markings on the side of the tool. These markings are used for design layout, including correct spacing of letters, stickers or any other medium in which the user desires accurate spacing. The markings may comprise a plurality of evenly-spaced apart vertical lines.

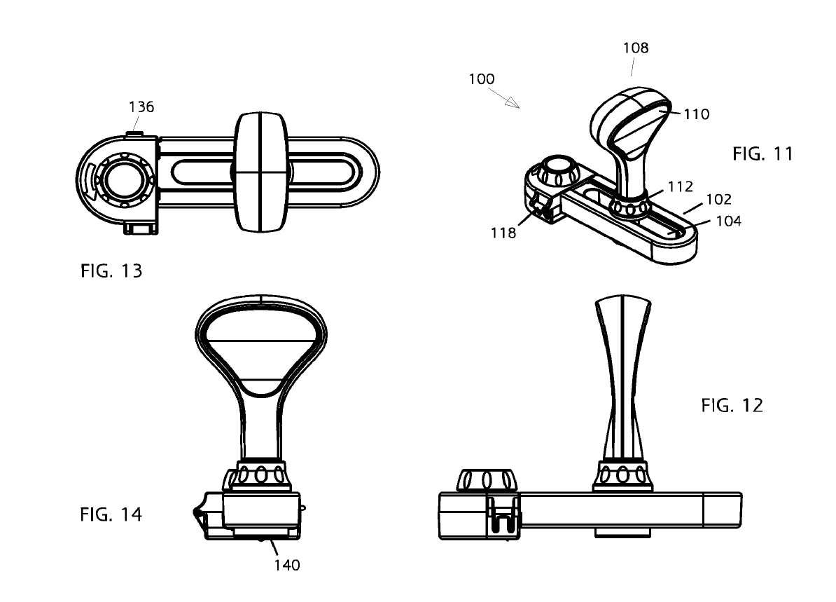

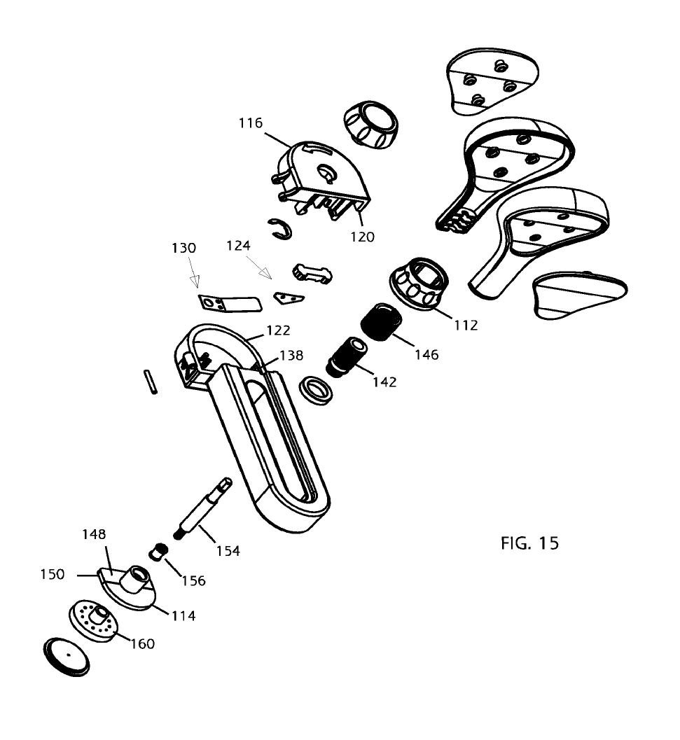

FIGS. 11-15 show the circle cutter 100 in accordance with the present invention. The circle cutter as shown includes a main housing or arm 102. The main housing includes an elongated portion having a longitudinally extending groove or slot 104. The main housing further includes a blade housing portion 106. The main housing in one embodiment is made of a clear plastic and includes a ruler or measuring indicia along either side. A handle 108 with a comfort grip extends from the groove and includes a tightening knob 112. It will be appreciated that the handle is adjustable along the length of the groove and is secured in place via the tightening knob and the clip 114. With particular reference to FIG. 15, the blade housing portion is shown to include a top portion 116 which is pivotally coupled to the bottom portion via a hinge having rod. The top cover may pivot about the hinge 118 to a fully closed position whereby the edge 120 of the top cover is in engagement with the edge 122 of the bottom portion.

The blade assembly 124 is received within the blade compartment and retained therein via a blade housing clip extending from the lower surface of the top cover. The blade housing clip retains the blade housing in a fixed manner with respect to the top cover. The spring 130 includes an attachment portion and a spring portion. The attachment portion is secured to the bottom side of the lower portion via suitable means, such as ultrasound welding, pins, or a screw extending through the attachment portion and into the lower portion. The spring portion is biased in a position raised above the lower side of the lower portion. With the top cover in the fully closed position, the spring portion is in engagement with the lower surface of the top cover, and thus urges the top cover away from the fully closed position. The top cover includes a release tab 136 which engages the channel 138 in the lower portion with the top cover in the fully closed position. The channel has a vertical length such that with the release tab in engagement with the channel, the release tab has a certain vertical movement allowing the top cover to move between the fully closed position and a position whereby the edge 120 is slightly raised above the edge 122. Thus, with the top cover closed and the release tab in engagement with the channel, the spring clip urges the top cover away from the fully closed position.

With the top cover in the fully closed position, the blade of the blade housing extends through a slit 140 in the bottom side of the bottom portion of the blade housing. However, with the spring clip urging the top cover away from the fully closed position, the blade does not extend through the slit, but rather is located within the blade housing.

The top cover includes an opening which receives a shaft of the rotating knob. The rotating knob is secured in place via a c-clip.

In one embodiment, the handle includes a first handle portion and a second handle portion. Each handle portion includes a recessed area having openings which receive the tabs on a rubber handle grip.

The clip receives a threaded brass insert 142 which extends through the groove. The upper portion of the threaded brass insert receives the plastic slide washer. The tightening knob includes a further brass insert 146 having internally threaded portion. The tightening knob is screwed onto the external threads of the insert having external threads.

The upper surface 148 of the clip comes into contact with the inner wall of the groove and between the first outer wall and the second outer wall. The edge 150 of the clip comes into physical contact with either the first or second outer wall and limits rotational movement of the clip. Thus, the tightening knob may be secured in place with respect to the main housing. The handle portions are assembled together with the shaft in a fixed manner. The shaft 154 extends through the brass inserts and the lower threaded portion of the shaft receives the threaded brass insert 156 located within the base 160. The lower edge of the shaft and the upper edge of the brass insert come into contact and limit the distance between the lower edge of the handle and the upper surface of the base. In this manner, the handle may be secured to the circle cutter and allow rotational movement even though the tightening knob is secured in place along the groove.

The main body of the circle cutter is provided with the adjustable ruler which allows the handle to slide along the main body to cut a circle having the desired dimension. In the embodiment where the elongated portion is made of clear plastic, other than the ruler or marking indicia, the user is able to view the picture or paper beneath the circle cutter before and during the cutting operation.

In operation, the user grips the tall handle with the user's non-dominant hand. The rotating knob is then positioned at approximately the eleven o'clock position for right-handed users and the one o'clock position for left-handed users. The user is then able to grasp the rotating knob with the dominant hand and pull the blade housing and blade towards the user in a clockwise direction to make a full 360 degree cut, or as desired. With the user applying the appropriate pressure to the rotating knob, the user urges the blade assembly against the spring, such that the blade extends through the slit and engages the paper under the circle cutter.

When the device is not in use, the blade is safely located within the blade housing so that it will not be exposed to a user during setting up of the tool for use.

A blade preferably extends outwardly from the bottom of the blade assembly near one end to facilitate the cutting process. Each of the blade assemblies is preferably removable and can be moved from one opening to another. Furthermore, the blade assembly can be turned upside-down to conceal the blade in a corresponding blade cavity for reasons such as safety concerns or storage.

In operation, a user rotates the arm around the post so that the blade, in contact with the desired material and maintained at an equal distance from its axis, creates a cut in a circular pattern. If desired, a second blade assembly can be attached to the arm at a distance from the axis not equal to the position of the original blade assembly so that when the user rotates the arm, two cuts are created simultaneously, resulting in a donut shaped cut.

An adjustable cutting blade assembly is slidably mounted within the slot. The adjustable cutting blade includes a combination cutting blade and blade holder. The width of the slot at the lower surface is adapted to accommodate longitudinal movement of the combination cutting blade and blade holder along the slot. The cutting blade holder may a made of plastic. Preferably, the cutting blade assembly provides for easy replacement of the combination cutting blade and blade holder.

The adjustable cutting blade assembly includes a sleeve received by the slot. The sleeve includes a lower annular flange which is received by the wider width of the slot, but abuts against the abutment or shoulder of the pivot art. The outer surface of the sleeve is threaded. A threaded nut rests upon the upper surface of the pivot arm and is threadingly coupled to the sleeve. A spring loaded dome rests over the sleeve. A spring is biased between the upper interior surface of the dome and a spring abutment extending from an inner wall of the sleeve. The dome includes a portion which depends from the dome and is adapted to receive the adjustable cutting blade assembly in a snug interference fit arrangement. It should be clear that the spring biases the dome and blade assembly in an upward manner, with the blade above the lower surface of the pivot arm. The dome may be depressed downward by a user, such that the blade assembly is lowered onto the working surface. It should be apparent that the working surface may comprise a sheet of paper or other material may be placed upon a support surface, wherein the blade may be used to cut the paper or material.

Many modifications and variations of the present invention are possible in light of the above teachings. It is therefore to be understood that within the scope of the appended claims, the invention may be practiced otherwise than as specifically described.

What is claimed is:

1. A kit for use in making a scrapbook, the kit comprising:
a cutting mat providing a working surface and a bottom surface, and a first edge with a first cutting mat attachment, and a second edge opposite from the first edge and having a second cutting mat attachment; and
a straight edge tool having a bottom surface adapted for resting upon the working surface, a first end having a first end attachment for removably coupling to the first cutting mat attachment, and a second end having a second end attachment for removably coupling to the second cutting mat attachment.

2. The kit of claim 1 wherein the first cutting mat attachment and the first end attachment include a pivotal connection, wherein the straight edge tool may be raised off of the working surface as it is pivotally rotated at the pivotal connection.

3. The kit of claim 2, wherein the second cutting mat attachment includes at least one notch along the second edge, and the second end attachment includes a flange for releasable engagement with the respective notch.

4. The kit of claim 3, wherein the flange is movably secured to the straight edge tool and includes a lower position and an upper position, whereby in the lower position with the tool resting upon the working surface and with the flange aligned with one of the notches, the flange is extended into the notch and locks the second end in place with respect to the cutting mat, and whereby in the upper position and the flange with the tool resting upon the working surface, the flange is above the working surface and the notch.

5. The kit of claim 4, wherein the first cutting mat attachment includes a first connector along the first edge, and an attachment device, the attachment device includes a second connector for releasably coupling to the first connector, the attachment device includes a first pivotal connector for releasably coupling to the first end attachment, and with the attachment device secured to the cutting mat via the releasable engagement of the first and second connectors, the pivotal connection is opposite one of the second cutting mat attachments.

6. The kit of claim 1, wherein the first cutting mat attachment includes at least one opening along the first edge, and an elongated attachment device, the elongated attachment device includes a first lower surface for adapted for resting upon the work surface of the cutting mat, and at least one pin extending from the first lower surface for engagement with a respective opening along the first edge of the cutting mat, the elongated attachment device includes an edge which substantially conforms to the first edge and is adapted for abutement with the first edge of the cutting mat, the elongated attachment device having a second lower surface which is lower than the first lower surface and is adapted to provide a continuous smooth surface with the bottom surface of the cutting mat, the elongated attachment device providing a groove for receiving the straight edge tool, wherein the straight edge tool includes a pin for engagement with the groove of the elongated attachment device to provide for a pivotal connection between the straight edge tool and the cutting mat.

7. The kit of claim 6, wherein the groove of the elongated attachment device includes two spaced apart and aligned grooves with a common axis extending through the longitudinal axis of the aligned grooves, and wherein the pin of the straight edge tool includes two pins having aligned longitudinal axis and extending in opposite directions, wherein each pin is adapted to be received by a respective groove of the elongated attachment device, further wherein the grooves and respective pins provide a snap fit arrangement.

8. The kit of claim 7, wherein the straight edge tool includes a handle, and a rail which define a longitudinal groove, wherein the groove is adapted to receive various tools or attachments, and wherein a ruler or measuring indicia are provided along an edge of the straight edge tool.

9. The kit of claim 1, wherein the second cutting mat attachment includes a notch along the second edge of the cutting mat, and the second end attachment includes a channel in the second end of the straight edge tool, the channel having generally vertical channel portion and a lower foot channel portion, with an abutment at the top of the vertical channel portion, a back wall along the vertical channel portion, a horizontally extending groove along the back wall and forms a horizontal ridge above the groove, a front wall along the foot channel portion, and further including a generally L-shaped movable latch which is received in the channel, the latch having a vertical stem portion and a lower foot portion, a flange depends from the lower foot portion, a vertical edge extends along the lower foot portion and a vertical edge extends along the vertical stem portion, the vertical stem portion includes a top side, and a spring clip extends downward from a portion of the vertical stem portion and includes a horizontally extending bead, whereby an upper unlock position is defined by the abutement which is adapted to engage the top side and limit the upper vertical movement of the latch and wherein the bead is generally trapped above the ridge and a lower locked position is defined by the bead generally trapped within the groove.

10. A circle cutter adaptable for use in making a scrapbook, the circle cutter comprising:
a longitudinally extending arm having a first end and a second or blade end, the arm having a longitudinal length, the arm having a slot extending longitudinally at least a portion of the length of the arm;
a blade housing located at the blade end, the blade housing having a lower surface and a blade capable of extending below the lower surface, the blade is aligned perpendicular to the arm, and a knob rotatably located on the blade housing;
a locking mechanism located at the slot, the locking mechanism having an unlocked and locked condition, wherein in the unlocked condition, the locking mechanism is generally free to move along the slot, and wherein in the locked condition, the locking mechanism is secured with respect to the arm;
a handle and base portion, the handle portion extending from the locking mechanism above the arm, the base portion located below the arm and extends from the locking mechanism, wherein the handle and base portion are free to rotate within the slot with the locking mechanism in the locked condition, and the handle and base portion move with the locking mechanism along the slot with the locking mechanism in the unlocked position.

11. The circle cutter of claim 10, wherein the arm includes parallel extending side wall, and parallel extending inner walls which define the slot, wherein the side walls extend above and below the inner walls, the arm having a first upper surface extending toward the slot from the top of the side walls, and a second upper surface, lower than the first upper surface, the second upper surface extending toward the first upper surface from the top of the inner walls, a vertical wall or edge joins the first and second upper surfaces.

12. The circle cutter of claim 11, wherein the locking mechanism includes a shaft having an upper end and a lower end and a bore extending through the shaft, the upper end including a threaded portion, the shaft extending through the slot, the shaft having a base at the lower end, and located below the inner wall and between the side walls, the base includes at least one side which comes into contact with the side walls during rotation of the shaft, a slide washer is received by the threaded portion and is located above the second upper surface and between the vertical edge, a threaded nut is threadingly received by the threaded portion of the shaft and is located above the slide washer and arm.

13. The circle cutter of claim 12 wherein the handle and base portion include a handle portion having a stem with a threaded lower end, the threaded lower end has a diameter less than the diameter of the stem and forms a shoulder, the handle portion includes an upper end having a handle with a lower handle shoulder, the stem extends through the bore of the shaft, a base portion includes a shaft extending upward from the base portion, the shaft forms a should and includes a bore having internal threads, the threaded lower end of the stem is threadingly received by the bore, wherein the base shoulder and stem shoulder come into contact and define a minimum distance between the base and the handle shoulder, whereby the handle and base are secured to the locking mechanism but remain free to rotate about the axis of the stem and arm.

14. The circle cutter of claim 10, wherein blade housing includes a lower body portion secured to the arm and an upper body portion coupled to the lower body portion by a hinge, the lower body portion includes a bottom side providing the lower surface, a spring is resiliently secured to the lower body portion, the lower body portion includes a blade slit extending in a direction perpendicular to the longitudinal axis of the arm, the upper body portion includes a connector for securing a blade assembly, the blade assembly includes a blade holder and a blade, wherein with the upper body portion rotated about the hinge to a closed position, the blade extends through the blade slit with a portion of the blade below the lower surface, a clasp arrangement secures the upper body portion with respect to the lower body portion, between the closed or cutting position with an edge of the upper body portion in contact with the edge of the lower body portion, and a safe position wherein the upper edge and lower edge are slightly spaced apart and the blade does not extend below the lower surface, and wherein with the clasp arrangement securing the upper body portion with respect to the lower body portion, the spring is in contact with the upper body portion and urges the upper body portion towards the safe position.

15. The circle cutter of claim 14, wherein the spring includes a flat spring having a base portion and a spring portion, wherein the base portion is secured to the lower body portion and the spring portion extends upward, and wherein the upper body portion includes a depending flange which is in contact with the spring portion with the upper body portion located in the closed or safe positions.
